(19) United States
(12) Patent Application Publication
(10) Pub. No.: US 2014/0347575 A1
(43) Pub. Date: Nov. 27, 2014

(54) CAPACITANCE TOUCH PANEL

(71) Applicant: TIANJIN FUNAYUANCHUANG TECHNOLOGY CO., LTD., Tianjin (CN)

(72) Inventors: PO-SHENG SHIH, New Taipei (TW); JIA-SHYONG CHENG, New Taipei (TW)

(73) Assignee: TIANJIN FUNAYUANCHUANG TECHNOLOGY CO.,LTD., Tianjin (CN)

(21) Appl. No.: 13/899,934

(22) Filed: May 22, 2013

(51) Int. Cl. G06F 3/044

(52) U.S. Cl. CPC G06F 3/044; Y10S 977/953; B82Y 99/00
USPC 349/12; 977/953

(57) ABSTRACT

A touch panel includes a cover glass having a surface, a transparent conductive layer located on the surface of the cover glass and having a first side and a second side opposite to the first side, at least one first electrode located on the first side and electrically connected with the transparent conductive layer, and at least one second electrode located on the second side and electrically connected with the transparent conductive layer. The transparent conductive layer includes a carbon nanotube film with resistance anisotropy. The carbon nanotube film has the smallest resistance along a low resistance direction D from the first side of the transparent conductive layer to the second side of the transparent conductive layer.

### BACKGROUND

1. Technical Field

The present disclosure relates to touch panels, particularly to a carbon nanotube based touch panel.

2. Description of Related Art

In recent years, various electronic apparatuses such as mobile phones, car navigation systems have advanced toward high performance and diversification. There is continuous growth in the number of electronic apparatuses equipped with optically transparent touch panels in front of their display devices such as liquid crystal panels. A user can operate the electronic apparatus by pressing a touch panel with a finger or a stylus while visually observing the display device through the touch panel. Thus a demand exists for such touch panels that are superior in visibility and reliable in operation. Due to a higher accuracy and sensitivity, the capacitance touch panels have been widely used.

A conventional multipoint capacitance touch panel includes a substrate, a plurality of parallel first strip-shaped transparent conductive layers located on a first surface of the substrate, and a plurality of parallel second strip-shaped transparent conductive layers located on a second surface of the substrate opposite to the first surface. The first strip-shaped transparent conductive layers are intercrossed with the second strip-shaped transparent conductive layers. However, the first second strip-shaped transparent conductive layers and the second strip-shaped transparent conductive layers are made of indium tin oxide (ITO) layers which are generally formed by means of ion-beam sputtering. This method is relatively complicated. Furthermore, the ITO layers are located on both the first and second surface of the substrate, thus the structure of the multipoint capacitance touch panel is complicated.

What is needed, therefore, is to provide a touch panel which can overcome the shortcoming described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic top view of one embodiment of a capacitance touch panel.

FIG. 2 is a schematic, cross-sectional view, along a line II-II of FIG. 1.

FIG. 3 is a scanning electron microscope (SEM) image of a carbon nanotube film.

FIG. 4 is a schematic, cross-sectional view of one embodiment of a device using the capacitance touch panel of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

References will now be made to the drawings to describe, in detail, various embodiments of the present capacitance touch panels.

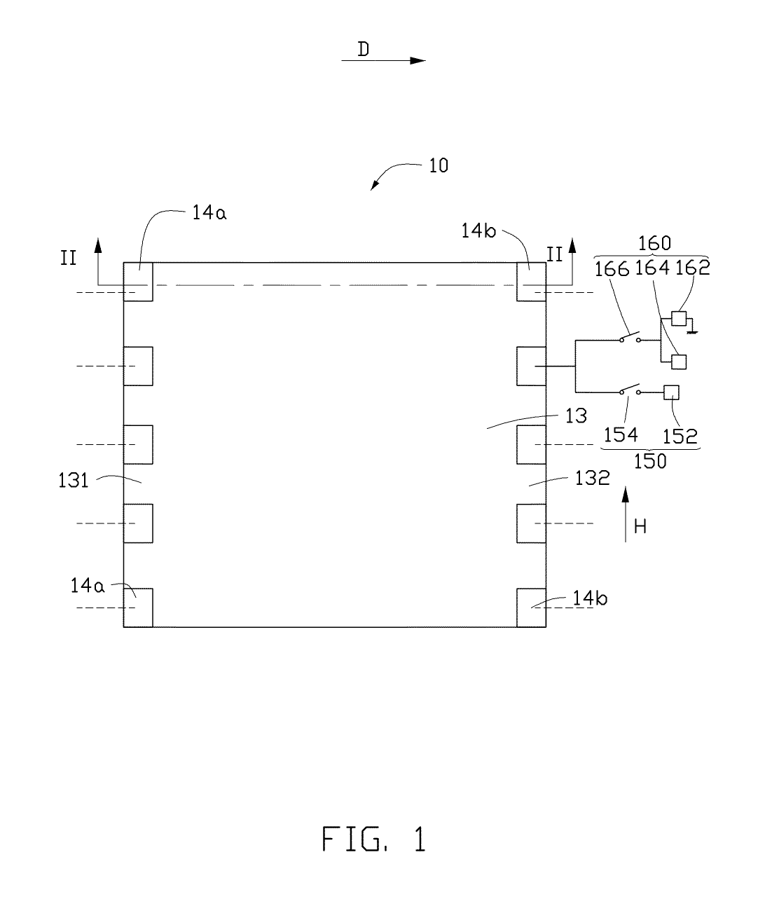

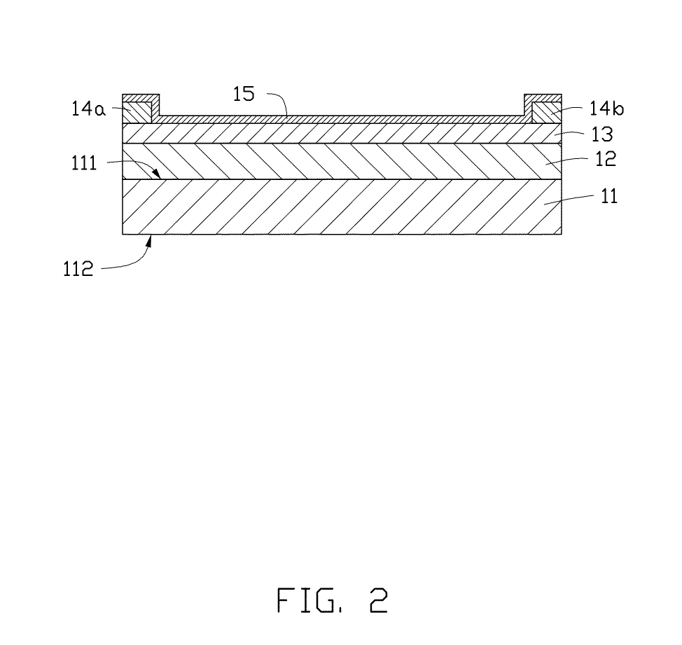

Referring to FIGS. 1 and 2, a capacitance touch panel 10 of one embodiment includes a cover glass 11, a transparent conductive layer 13, at least one first electrode 14a and at least one second electrode 14b.

The cover glass 11 has a first surface 111 and a second surface 112 opposite to the first surface 111. The transparent conductive layer 13 is located on the first surface 111 of the cover glass 11. The transparent conductive layer 13 has a first side 131 and a second side 132 opposite to the first side 131. The at least one first electrode 14a is located on the first side 131 and electrically connected with the transparent conductive layer 13. The at least one second electrode 14b is located on the second side 132 and electrically connected with the transparent conductive layer 13.

The cover glass 11 can be a flat or curved transparent substrate. The cover glass 11 can comprise rigid materials such as glass, quartz, diamond, plastic or any other suitable material. The cover glass 11 can also comprise flexible materials such as polycarbonate (PC), polymethyl methacrylate acrylic (PMMA), polyimide (PI), PET, polyethylene (PE), polyether polysulfones (PES), polyvinyl polychloride (PVC), benzocyclobutenes (BCB), polyesters, or acrylic resin. The cover glass 11 is configured to support and protect other elements. The thickness of the cover glass 11 can range from about 50 micrometers to about 500 micrometers, for example from about 100 micrometers to about 200 micrometers. In another embodiment, the cover glass 11 is a rectangular glass plate.

The transparent conductive layer 13 includes a carbon nanotube film. The carbon nanotube film includes a plurality of carbon nanotubes substantially in parallel with each other and arranged to extend along the same direction. A majority of the carbon nanotubes are arranged to extend along the direction substantially parallel to the surface of the carbon nanotube film. The carbon nanotubes in the carbon nanotube film can be single-walled, double-walled, or multi-walled carbon nanotubes. The length and diameter of the carbon nanotubes can be selected according to need, for example the diameter can be in a range from about 0.5 nanometers to about 50 nanometers and the length can be in a range from about 200 nanometers to about 900 nanometers. The thickness of the carbon nanotube film can be in a range from about 0.5 nanometers to about 100 micrometers, for example in a range from about 10 nanometers to about 200 nanometers.

The carbon nanotube film is resistance anisotropy having the smallest resistance along the extending direction of the plurality of carbon nanotubes and the greatest resistance along the direction perpendicular with the extending direction of the plurality of carbon nanotubes. The extending direction of the plurality of carbon nanotubes is defined as a low resistance direction D, and the direction perpendicular with the low resistance direction D is defined as a high resistance direction H. The low resistance direction D is perpendicular with the first side 131 and the second side 132. The high resistance direction H is parallel with the first side 131 and the second side 132. A majority of the carbon nanotubes are arranged to extend along the low resistance direction D and a minority of the carbon nanotubes are arranged randomly so that the carbon nanotube film has conductivity along the high resistance direction H.

The carbon nanotube film can be a substantially pure structure of the carbon nanotubes, with few impurities and chemical functional groups. The carbon nanotube film has a good flexibility because of the good flexibility of the carbon nanotubes therein. The carbon nanotube film is a free-standing structure. The term “free-standing structure” means that the carbon nanotube film can sustain the weight of itself when it is hoisted by a portion thereof without any significant damage to its structural integrity. Thus, the carbon nanotube film can be suspended by two spaced supports.

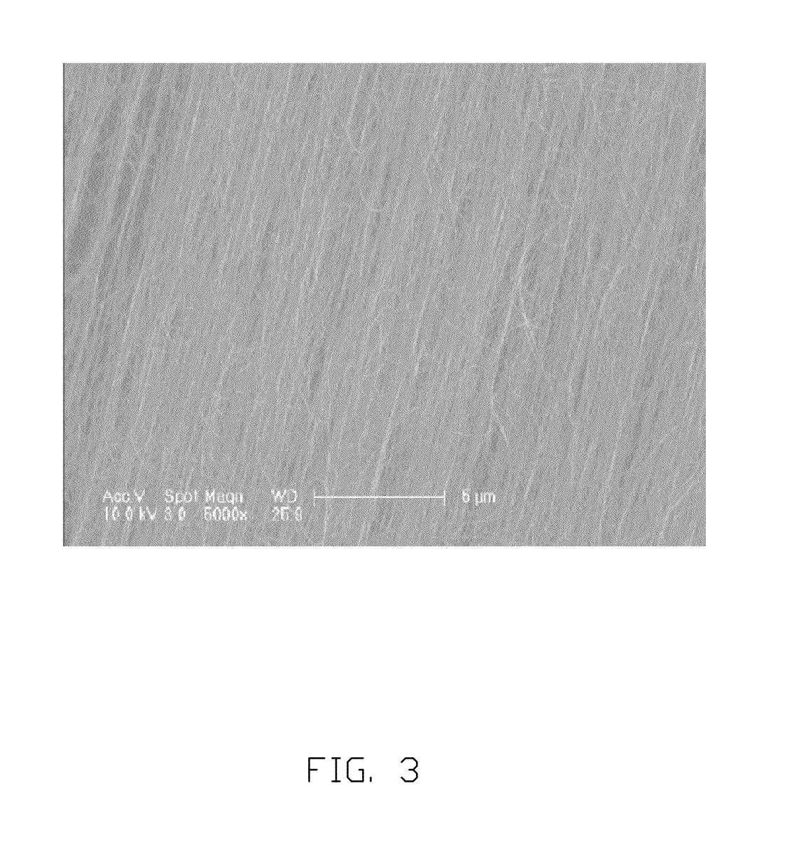

In one embodiment, the transparent conductive layer 13 is a single carbon nanotube film. The carbon nanotube film includes a plurality of successive and oriented carbon nanotubes joined end-to-end by van der Waals attractive force therebetween and arranged to extend along the low resistance direction D. Referring to FIG. 3, each carbon nanotube film includes a plurality of successively oriented carbon nanotube segments joined end-to-end by van der Waals attractive force therebetween. Each carbon nanotube segment includes a plurality of carbon nanotubes parallel to each other, and combined by van der Waals attractive force therebetween. Some variations can occur in the carbon nanotube film. The carbon nanotubes in the carbon nanotube film are oriented along a preferred orientation. The carbon nanotube film can be treated with an organic solvent to increase the mechanical strength and toughness and reduce the coefficient of friction of the carbon nanotube film. A thickness of the carbon nanotube film can range from about 0.5 nanometers to about 100 micrometers.

In one embodiment, the transparent conductive layer 13 can include at least two stacked carbon nanotube films or two or more coplanar carbon nanotube films. Additionally, when the carbon nanotubes in the carbon nanotube film are aligned along one preferred orientation, an angle can exist between the orientations of carbon nanotubes in adjacent films, whether stacked or adjacent. Adjacent carbon nanotube films can be combined by only the van der Waals attractive force therebetween. The aligned directions of the carbon nanotubes in two adjacent carbon nanotube films are the same. Stacking the carbon nanotube films will also add to the structural integrity of the carbon nanotube film.

The shape of the carbon nanotube film can be selected according to the touch-view area of the touch panel 10. In one embodiment, the shape of the carbon nanotube film is the same as the shape of cover glass 11.

The carbon nanotube film can be made by following substeps:

step (S10), providing a carbon nanotube array on a substrate; and

step (S12), drawing out the carbon nanotube film from the carbon nanotube array by using a tool.

In step (S10), the carbon nanotube array includes a plurality of carbon nanotubes that are parallel to each other and substantially perpendicular to the substrate. The height of the plurality of carbon nanotubes can be in a range from about 50 micrometers to 900 micrometers. The carbon nanotube array can be formed by the substeps of: step (S101) providing a substantially flat and smooth substrate; step (S102) forming a catalyst layer on the substrate; step (S103) annealing the substrate with the catalyst layer in air at a temperature approximately ranging from 700° C. to 900° C. for about 30 minutes to 90 minutes; step (S104) heating the substrate with the catalyst layer to a temperature approximately ranging from 500° C. to 740° C. in a furnace with a protective gas therein; and step (S105) supplying a carbon source gas to the furnace for about 5 minutes to 30 minutes and growing the carbon nanotube array on the substrate.

In step (S101), the substrate can be a P-type silicon wafer, an N-type silicon wafer, or a silicon wafer with a film of silicon dioxide thereon. A 4-inch P-type silicon wafer is used as the substrate. In step (S102), the catalyst can be made of iron (Fe), cobalt (Co), nickel (Ni), or any alloy thereof. In step (S103), the protective gas can be made up of at least one of nitrogen (N₂), ammonia (NH₃), and a noble gas. In step (S 105), the carbon source gas can be a hydrocarbon gas, such as ethylene (C₂H₄), methane (CH₄), acetylene (C₂H₂), ethane (C₂H₆), or any combination thereof. The carbon nanotube array formed under the above conditions is essentially free of impurities, such as carbonaceous or residual catalyst particles.

In step (S 12), the drawing out the carbon nanotube film includes the substeps of: step (S121) selecting one or more of carbon nanotubes in a predetermined width from the carbon nanotube array; and step (S 122) drawing the selected carbon nanotubes to form nanotube segments at an even and uniform speed to achieve the carbon nanotube film. The carbon nanotube film has the smallest resistance along the drawing direction and the greatest resistance along a direction perpendicular to the drawing direction. Thus, the carbon nanotube film is resistance anisotropy.

In step (S121), the carbon nanotubes having a predetermined width can be selected by using an adhesive tape, such as the tool, to contact the super-aligned array. In step (S122), the drawing direction is substantially perpendicular to the growing direction of the carbon nanotube array. Each carbon nanotube segment includes a plurality of carbon nanotubes parallel to each other.

More specifically, during the drawing process, as the initial carbon nanotube segments are drawn out, other carbon nanotube segments are also drawn out end-to-end due to van der Waals attractive force between ends of adjacent segments. This process of drawing helps provide a continuous and uniform carbon nanotube film having a predetermined width can be formed.

The width of the carbon nanotube film depends on a size of the carbon nanotube array. The length of the carbon nanotube film can be arbitrarily set as desired. In one useful embodiment, when the substrate is a 4-inch P-type silicon wafer, the width of the carbon nanotube film can be in a range from about 0.01 centimeters to about 10 centimeters.

Furthermore, the carbon nanotube film can be etched or irradiated by laser. After being irradiated by laser, a plurality of parallel carbon nanotube conductive strings will be formed and the resistance anisotropy of the carbon nanotube film will not be damaged because the carbon nanotube substantially extending not along the drawing direction are removed by burning. Each carbon nanotube conductive string comprises a plurality of carbon nanotubes joined end-to-end by van der Waals attractive force.

The carbon nanotube film can be located on the first surface 111 of the cover glass 11 directly and adhered to the cover glass 11 by an adhesive layer 12. The adhesive layer 12 is configured to fix the carbon nanotube film on the cover glass 11. The adhesive layer 12 can be transparent, opaque, or translucent. In one embodiment, the transmittance of the adhesive layer 12 can be greater than 75%. The adhesive layer 12 can be made of pressure sensitive material, thermo sensitive material or photosensitive material such as UV glue. The thickness of the adhesive layer 12 can be in a range from about 2 micrometers to about 7 micrometers. In one embodiment, the adhesive layer 12 is a UV glue layer with a thickness of 5 micrometers. If the adhesive layer 12 is too thick, the carbon nanotubes of the carbon nanotube film may be embedded or immersed in the adhesive layer 12 and cannot contact the at least one first electrode 14a and the at least one second electrode 14b. If the thickness of the adhesive layer 12 is too small, the carbon nanotube film cannot be fixed firmly.

Alternatively, a protection layer 15 can be located on the transparent conductive layer 13 to cover the carbon nanotube film, the at least one first electrode 14a and the at least one second electrode 14b. The carbon nanotube film is sandwiched between the adhesive layer 12 and the protection layer 15. The protection layer 15 is configured to protect the carbon nanotube film in order to protect the carbon nanotube film from being destroyed. When the capacitance touch panel 10 is installed on an electric device, the protection layer 15 can be removed. The protection layer 15 can be made of rigid materials such as glass, quartz, diamond, or plastic. The protection layer 15 can also be made of flexible materials such as PC, PMMA, PI, PET, PE, PES, PVC, BCB, polyesters, or acrylic resin. In one embodiment, the protection layer 15 is a glass plate with a thickness of 2 millimeters.

The first electrodes 14a and the second electrodes 14b can be made of conductive material such as metal, metallic carbon nanotubes, conductive polymer, conductive silver paste, or ITO, and can be made by etching a metal film, etching an ITO film, or printing a conductive silver paste. The shape of the first electrodes 14a and the second electrodes 14b can be selected according to need such as layer-shaped, strip-shaped, block-shaped, or rod-shaped. In one embodiment, both the first electrodes 14a and the second electrodes 14b are made of conductive silver paste and made by printing conductive silver paste concurrently.

The number of the first electrodes 14a and the second electrodes 14b can be one or more. A plurality of first electrodes 14a can be located on the first side 131 and arranged along the direction H, and a plurality of second electrodes 14b can be located on the second side 132 and arranged along the direction H. The distance between two adjacent first electrodes 14a and the distance between two adjacent second electrodes 14b can be in a range from about 1 millimeter to about 5 millimeters. The length of the each of the first electrodes 14a and second electrodes 14b is parallel with the direction H and can be in a range from about 1 millimeter to about 5 millimeters. Thus, the capacitance touch panel 10 can position accurately. In one embodiment, five first electrodes 14a are spaced from each other with a distance of about 3 millimeters and each has a length of 1 millimeter, and five second electrodes 14b are spaced from each other with a distance of about 3 millimeters and each has a length of 1 millimeter. Each of the first electrodes 14a is located corresponding to one of the second electrodes 14b to form an electrodes pair. The first electrode 14a and the second electrode 14b of each electrodes pair are located on a line parallel with the direction D.

Furthermore, the capacitance touch panel 10 includes a driving circuit 150 and a sensing circuit 160 in parallel. The at least one first electrode 14a and the at least one second electrode 14b are electrically connected with the driving circuit 150 and the sensing circuit 160. The driving circuit 150 includes a charge circuit 152 and a first switch 154 configured to control the charge circuit 152. The charge circuit 152 is electrically connected with the at least one first electrode 14a and the at least one second electrode 14b via the first switch 154 in series. The charge circuit 152 is electrically connected to a power (not shown) in work. The sensing circuit 160 includes a memory circuit 162, a read circuit 164 and a second switch 166 configured to control the memory circuit 162 and the read circuit 164. The memory circuit 162 and the read circuit 164 are in parallel and together electrically connected with the at least one first electrode 14a and the at least one second electrode 14b via the second switch 166 in series. The memory circuit 162 can be ground via a resistance (not shown).

The work principle of the capacitance touch panel 10 is described below. When the second surface 112 of the cover glass 11 is touched by an object such as a finger or a stylus, a coupling capacitance C is produced between the object and the transparent conductive layer 13 at the touch point. The resistances between the touch point and the first electrodes 14a are R₁ₙ, wherein n represents the number of the first electrodes 14a, and n=1, 2, 3 . . . y, x, z. The resistances between the touch point and the second electrodes 14b are R₂ₙ, wherein n represents the number of the second electrodes 14b, and n=1, 2, 3 . . . y, x, z.

When the second surface 112 of the cover glass 11 is touched by the object at a single touch point. The driving circuit 150 inputs a first pulse signal to each of the first electrodes 14a, the sensing circuit 160 reads the resistances R₁ₙ and coupling capacitance C to obtain the product of R₁ₙ×C. A first curve can be simulated according to the products of R₁ₙ×C. The coordinate of the touch point along the direction H can be calculated according to the first curve by following steps. First, the maximum value R₁ₖC, the minimum value R₁ₓC, the second minimum value R_{1y}C, and the third minimum value R_{1z}C which adjacent to the minimum value R₁ₓC of the first curve are obtained. Second, the coordinates Xx, Xy and Xz along the direction H of the values R₁ₓC, R_{1y}C and R_{1z}C are obtained. Finally, the coordinate of the touch point along the direction H is calculated by Interpolation Method. Then the driving circuit 150 inputs a second pulse signal to each of the second electrodes 14b, the sensing circuit 160 will read the resistances R₂ₙ and coupling capacitance C to obtain the product of R₂ₙ×C. A second curve can be simulated according to the product of R₂ₓ×C. The coordinate of the touch point along the direction D can be calculated according to the second curve by following steps. First, the minimum value R₂ₙ×C, and the second minimum value R_{2y}C adjacent to the minimum value R₂ₙ×C of the second curve are obtained. Second, the coordinate of the touch point is calculated along the direction D according to the rate

$$\frac{{R}_{1 x} C + {R}_{1 y} C}{{R}_{2 x} C + {R}_{2 y} C} .$$

When the second surface 112 of the cover glass 11 is touched by the object at a plurality of touch points, the coordinates of the plurality of touch points along the direction H can be calculated according to the first curve by following steps. First, a plurality of minimum values R₁ₓ₁C, R₁ₓ₂C . . . R₁ₓₘC of a plurality of troughs of the first curve are obtained, wherein m represents the number of the troughs. Second, a plurality of second minimum value R_{1y1}C, R_{1y2}C . . . R_{1ym}C adjacent to the values R₁ₓ₁C, R₁ₓ₂C . . . R₁ₓₘC are obtained. Third, the coordinates X₁ₓₘ, X_{1ym} along the direction H of the two first electrodes 14a corresponding to the two values R₁ₓₘC and R_{1ym}C are obtained. Finally, the coordinate of the plurality of touch points along the direction H is calculated by interpolation method. The coordinates of the plurality of touch points along the direction D can be calculated according to the second curve by following steps. First, the minimum value R₂ₓC, and the second minimum value R_{2y}C adjacent to the minimum value R₂ₓC of the second curve are obtained. Second, the coordinate of the touch point is calculated along the direction D according to the rate

$$\frac{{R}_{1 x} C + {R}_{1 y} C}{{R}_{2 x} C + {R}_{2 y} C} .$$

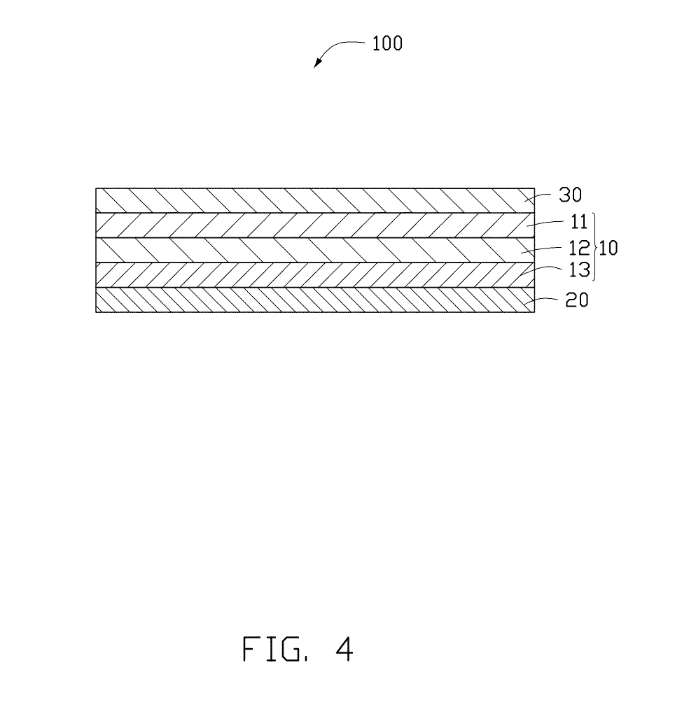

Referring to FIG. 4, one embodiment of a display device 100 using the capacitance touch panel 10 is shown. The display device 100 includes a display 20 and the capacitance touch panel 10. The capacitance touch panel 10 can be located on the display 20 with the transparent conductive layer 13 in contact with the display 20 or spaced from the display 20. In one embodiment, the transparent conductive layer 13 is fixed on the display 20 by an insulative transparent adhesive layer. The display 20 can be liquid crystal display, field emission display, plasma display, electroluminescence display, vacuum fluorescent display or cathode ray tube display. Furthermore, the display device 100 can include one or more function layer such as polarizer or shielding layer located between the display 20 and the capacitance touch panel 10. Furthermore, a decoration film 30 can be located on the cover glass 11.

It is to be understood that the above-described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A capacitance touch panel, comprising:
a cover glass having a surface;
a transparent conductive layer located on the surface and having a first side and a second side opposite to the first side, wherein the transparent conductive layer comprises a carbon nanotube film with resistance anisotropy, and the carbon nanotube film has the smallest resistance along a low resistance direction D from the first side of the transparent conductive layer to the second side of the transparent conductive layer;
at least one first electrode located on the first side of the transparent conductive layer and electrically connected with the transparent conductive layer; and
at least one second electrode located on the second side of the transparent conductive layer and electrically connected with the transparent conductive layer.

2. The capacitance touch panel of claim 1, wherein the cover glass is a curved transparent substrate.

3. The capacitance touch panel of claim 1, wherein the carbon nanotube film has the greatest resistance along a high resistance direction H that is perpendicular to the low resistance direction D.

4. The capacitance touch panel of claim 3, wherein the high resistance direction H is parallel with the first side and the second side of the transparent conductive layer.

5. The capacitance touch panel of claim 1, wherein the carbon nanotube film comprises a plurality of carbon nanotubes substantially in parallel with each other and arranged to extend along the low resistance direction D.

6. The capacitance touch panel of claim 5, wherein the plurality of carbon nanotubes are joined end-to-end by van der Waals attractive force therebetween along the low resistance direction D.

7. The capacitance touch panel of claim 5, wherein a majority of the plurality of carbon nanotubes are arranged to extend along a direction substantially parallel to a surface of the carbon nanotube film.

8. The capacitance touch panel of claim 1, wherein the carbon nanotube film is a substantially pure structure of carbon nanotubes.

9. The capacitance touch panel of claim 1, wherein the carbon nanotube film is a free-standing structure.

10. The capacitance touch panel of claim 1, further comprising an adhesive layer located between the carbon nanotube film and the cover glass.

11. The capacitance touch panel of claim 1, further comprising a protection layer located on the transparent conductive layer to cover the carbon nanotube film, the at least one first electrode and the at least one second electrode.

12. The capacitance touch panel of claim 1, further comprising a driving circuit and a sensing circuit in parallel.

13. A capacitance touch panel, comprising:
a cover glass having a surface;
a carbon nanotube film located on the surface and having a first side and a second side opposite to and parallel with the first side, wherein the carbon nanotube film has the greatest resistance along a high resistance direction H parallel with the first side of the carbon nanotube film and the smallest resistance along a low resistance direction D perpendicular with the first side of the carbon nanotube film;
an adhesive layer located between the carbon nanotube film and the cover glass;
a plurality of first electrodes located on and arranged along the first side of the carbon nanotube film and electrically connected with the carbon nanotube film; and
a plurality of second electrodes located on and arranged along the second side of the carbon nanotube film and electrically connected with the carbon nanotube film.

14. The capacitance touch panel of claim 13, wherein the carbon nanotube film comprises a plurality of successive and oriented carbon nanotubes joined end-to-end by van der Waals attractive force therebetween and arranged to extend along the low resistance direction D.

15. The capacitance touch panel of claim 13, wherein the carbon nanotube film is a substantially pure structure of carbon nanotubes.

16. The capacitance touch panel of claim 13, wherein a thickness of the adhesive layer is in a range from about 2 micrometers to about 7 micrometers.

17. The capacitance touch panel of claim 13, further comprising a protection layer located on the carbon nanotube film to cover the carbon nanotube film, the plurality of first electrodes and the plurality of second electrodes.

18. The capacitance touch panel of claim 13, further comprising a driving circuit and a sensing circuit in parallel.

19. A capacitance touch panel, consisting of:
a cover glass having a surface;
a carbon nanotube film located on the surface and having a first side and a second side opposite to and parallel with the first side, wherein the carbon nanotube film comprises a plurality of carbon nanotubes substantially in parallel with each other and arranged to extend along a low resistance direction D from the first side to the second side;
a plurality of first electrodes located on and arranged along the first side and electrically connected with the carbon nanotube film; and
a plurality of second electrodes located on and arranged along the second side and electrically connected with the carbon nanotube film.
